(19) United States
(12) Patent Application Publication
(10) Pub. No.: US 2015/0356685 A1
(43) Pub. Date: Dec. 10, 2015

(54) SYSTEM AND METHOD FOR ADMINISTERING EXTREME WEATHER INSURANCE DATA

(71) Applicant: Hartford Fire Insurance Company, Hartford, CT (US)

(72) Inventors: Charles Gregory Lindberg, West Hartford, CT (US); Theresa W. Milone, Simsbury, CT (US); Jeffrey G. Olmstead, Bloomfield, CT (US); Clifton L. Roberson, San Antonio, TX (US); Mark Daren Shuffler, Rock Hill, SC (US); Christine Williams, Simsbury, CT (US)

(21) Appl. No.: 14/297,211

(22) Filed: Jun. 5, 2014

(51) Int. Cl. G06Q 40/08

(52) U.S. Cl. CPC G06Q 40/08

(57) ABSTRACT

According to some embodiments, information about an insurance claim associated with a base insurance policy and a weather event may be received. Based on the received information, it may be determined if the insurance claim is associated with an amount of loss that exceeds limits of the base insurance policy and stretch endorsement. It may also be determined if the insurance claim is associated with a type of loss covered by an extreme weather endorsement of the base insurance policy and associated stretch endorsement. Further, it may be determined if the extreme weather endorsement is associated with the insurance policy and if the weather event satisfies an extreme weather trigger condition. If the limits are exceeded, the type of loss is covered, the extreme weather endorsement is associated with the insurance policy, and the weather event satisfies the extreme weather trigger condition, payment in connection with the insurance claim may be facilitated.

### BACKGROUND

A consumer may purchase an insurance policy to cover potential losses that might result from an extreme weather event (e.g., a hurricane or tornado). For example, a consumer who has several windows broken due to a hurricane might file an insurance claim to cover the cost of repairing those windows. Moreover, a consumer may purchase a “stretch endorsement” to increase the amount of coverage associated with the base insurance policy. For example, a consumer with a base insurance policy having a $10,000 annual limit for a particular type of loss might purchase a stretch endorsement to increase that limit to $25,000.

There are certain types of damages, however, that might not be covered by a base insurance policy and/or a stretch endorsement. For example, if a hurricane causes a flood that destroys a substation providing electric power to a consumer's business, he or she may be unable to operate the business and, as a result, suffer a loss of business income. Because the physical damage occurred at the substation (and not the consumer's business), a base insurance policy and/or stretch endorsement may not cover the loss of business income. As another example, the total amount of damage caused by a weather event may be so large that even a stretch endorsement will not cover all of the loss. The risk of these types of damages may be especially significant in the case of catastrophic weather events.

It would be desirable to provide systems and methods to facilitate the provision of insurance associated with extreme weather events in an automated, efficient, and accurate manner.

### SUMMARY OF THE INVENTION

According to some embodiments, systems, methods, apparatus, computer program code and means may be provided to facilitate the provision of insurance associated with extreme weather events in an automated, efficient, and accurate manner. In some embodiments, information about an insurance claim associated with a base insurance policy and a weather event may be received. Based on the received information, it may be determined if the insurance claim is associated with an amount of loss that exceeds limits of the base insurance policy and stretch endorsement. It may also be determined if the insurance claim is associated with a type of loss covered by an extreme weather endorsement of the base insurance policy and associated stretch endorsement. Further, it may be determined if the extreme weather endorsement is associated with the insurance policy and if the weather event satisfies an extreme weather trigger condition. If the limits are exceeded, the type of loss is covered, the extreme weather endorsement is associated with the insurance policy, and the weather event satisfies the extreme weather trigger condition, payment in connection with the insurance claim may be facilitated.

A technical effect of some embodiments of the invention is an improved and computerized method of facilitating the provision of insurance associated with extreme weather events. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a claims processing system according to some embodiments of the present invention.

FIG. 2 illustrates a claims processing method according to some embodiments of the present invention.

FIG. 3 illustrates a method associated with annual limits and sub-limits according to some embodiments of the present invention.

FIG. 4 illustrates an example of an extreme weather endorsement coverage display according to some embodiments.

FIG. 5 is an example of flood damage caused by a catastrophic weather event according to some embodiments.

FIG. 6 is an example of an insurance claim processed according to some embodiments.

FIG. 7 is an example of an insurance entity platform according to some embodiments.

FIG. 8 is a tabular portion of an insurance policy database according to some embodiments.

FIG. 9 is a tabular portion of an insurance claim database according to some embodiments.

FIG. 10 is block diagram of an underwriting system according to some embodiments of the present invention.

FIG. 11 illustrates an underwriting method according to some embodiments of the present invention.

FIG. 12 illustrates a system architecture within which some embodiments related to policy insurance and decisioning may be implemented.

FIG. 13 is a system architecture within which some embodiments relating to claim processing may be implemented.

FIG. 14 illustrates an insurance pricing example display in accordance with some embodiments.

### DETAILED DESCRIPTION

According to some embodiments described herein, a consumer may purchase an “extreme weather endorsement” in addition to a base insurance policy and a stretch endorsement (e.g., an eligible stretch endorsement that is capable of being associated with an extreme weather endorsement). The extreme weather endorsement may, for example, arrange for the insurer to pay up to a pre-defined limit for certain types of damages that result from an “extreme weather event” at each of one or more premises. As used herein, the phrase “extreme weather event” may refer to, for example, a windstorm, a hailstorm, a tornado, a cyclone, a derecho, a named storm, a named hurricane, a snowstorm, a blizzard, an ice storm, a dust storm, a sand storm, a wildfire, and/or a brushfire.

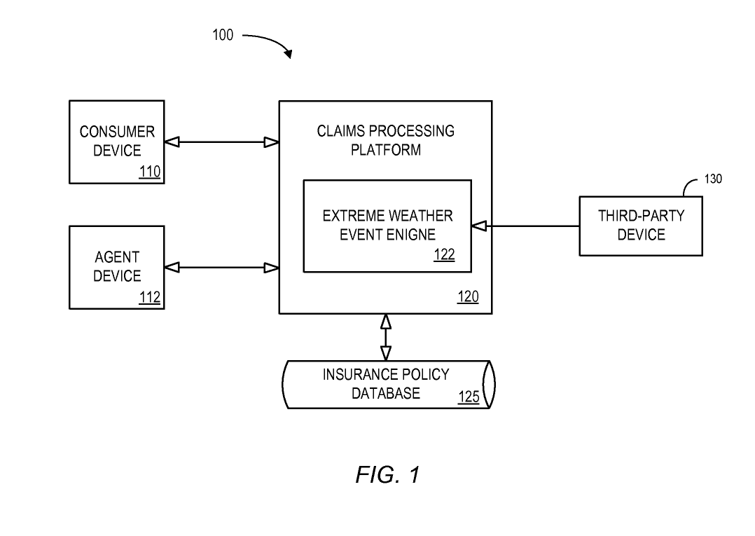

When a consumer who purchased an extreme weather endorsement suffers certain types of damages as a result of an extreme weather event, he or she may file an insurance claim to receive payment from the insurance company. If a weather event does not qualify as an “extreme weather event,” the extreme weather endorsement may not cover any resulting damages. According to some embodiments, a third party (e.g., a party other than the insurer and insured) may determine if a weather event qualifies as an extreme weather event. To help facilitate the provision of insurance and payment of claims associated with extreme weather events, FIG. 1 is a block diagram of a system 100 according to some embodiments of the present invention. In particular, a claims processing platform 120 may receive information from remote consumer devices 110 and/or insurance agent devices 112. The claims processing platform 120 might be associated with, for example, an insurance company or an entity that provides consumers with claims processing services. The consumer devices 110 and agent devices 112 might comprise, for example, Personal Computers (PCs), laptop computers, hand-held computers, wireless devices, smartphones, set-top boxes, and/or kiosks that can transmit information to and receive information from the claims processing platform 120. By way of examples, a consumer device 110 might be associated with a consumer's home computer, vehicle computer, or smartphone executing a browser or application that exchanges information with a web server associated with the claims processing platform 120. Similarly, a consumer might transmit information via an agent device 112. Based on information received from consumers, the claims processing platform 120 may process a claim using an extreme weather event engine 122 and transmit a result and/or payment back to the consumer device 110.

According to some embodiments, an “automated” claims processing platform 120 and/or extreme weather event engine 122 may facilitate an exchange of information. As used herein, the term “automated” may refer to, for example, actions that can be performed with little or no human intervention. By way of example only, the claims processing platform 120 and/or extreme weather event engine 122 may include and/or communicate with a PC, an enterprise server, or a database farm. According to some embodiments, the claims processing platform 120 and/or extreme weather event engine 122 is further associated with a salesforce automation, a Consumer Relationship Management (“CRM”) application, a Customer Service Manager (“CSM”)/content management system such as interwoven, Fatwire, etc.

As used herein, devices, including those associated with the claims processing platform the 120, extreme weather event engine 122, and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The claims processing platform 120 may access information in one or more local insurance policy databases 125. The database 125 may include, for example, policy holder information, consumer data, and/or information about endorsements associated with insurance policies. As will be described further below, the local database 125 may be used to help determine an appropriate response to an insurance claim.

Although a single claims processing platform 120 and a single extreme weather event engine 122 are shown in FIG. 1, any number of such devices may be included. Moreover, various devices described herein might be combined according to embodiments of the present invention. For example, in some embodiments, the claims processing platform 120 and insurance policy database 125 might be co-located and/or may comprise a single apparatus.

According to some embodiments, the claims processing platform 120 may also receive information from a remote third-party device 130. The remote third-party device 130 might be, for example, associated with a third party service that makes a determination as to whether or not a weather event should be classified as a catastrophic occurrence. By way of example, ISOnet® PCS®, an online subscription based delivery service for information from Property Claim Services® (PCS®), may provide information about catastrophes and weather incidents in the United States. In particular, the claims processing platform 120 may receive catastrophe bulletins that include the latest details on recent and past catastrophes, with an ability to select information by date, state, peril, or catastrophe serial number.

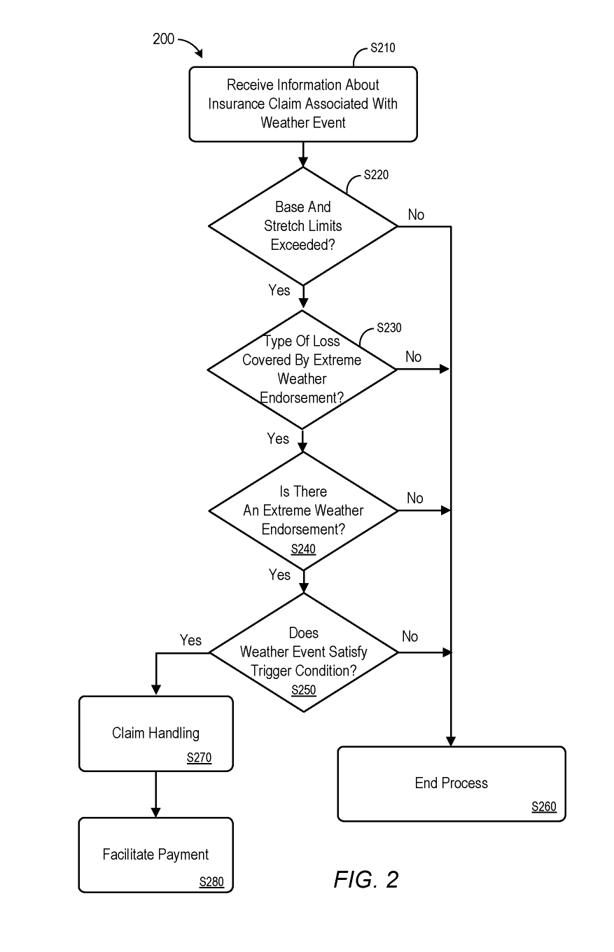

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, information about an insurance claim associated with an insurance policy may be received by an insurance entity. As used herein, the phrase insurance entity may refer to, for example, an insurance company or service associated with an insurer. The received insurance claim may be, according to some embodiments, associated with a base insurance policy (e.g., having a stretch endorsement) and a “weather event.” Note that an extreme weather endorsement might be associated with a single location (e.g., a particular building) or a plurality of separate locations.

Note that, according to some embodiments, claims may be filed under an extreme weather endorsement after any applicable base insurance policy and/or stretch endorsement limits have been met. That is, the base insurance policy and/or stretch endorsements may be used first (if applicable) and then, after limits on those are exceeded, claims may be processed under the extreme weather endorsement. Thus, at S220 the system may determine if those limits have been exceeded. If not, the extreme weather process may end at S260 (and claim handling may be performed in accordance with the normal insurance policy and/or stretch endorsement).

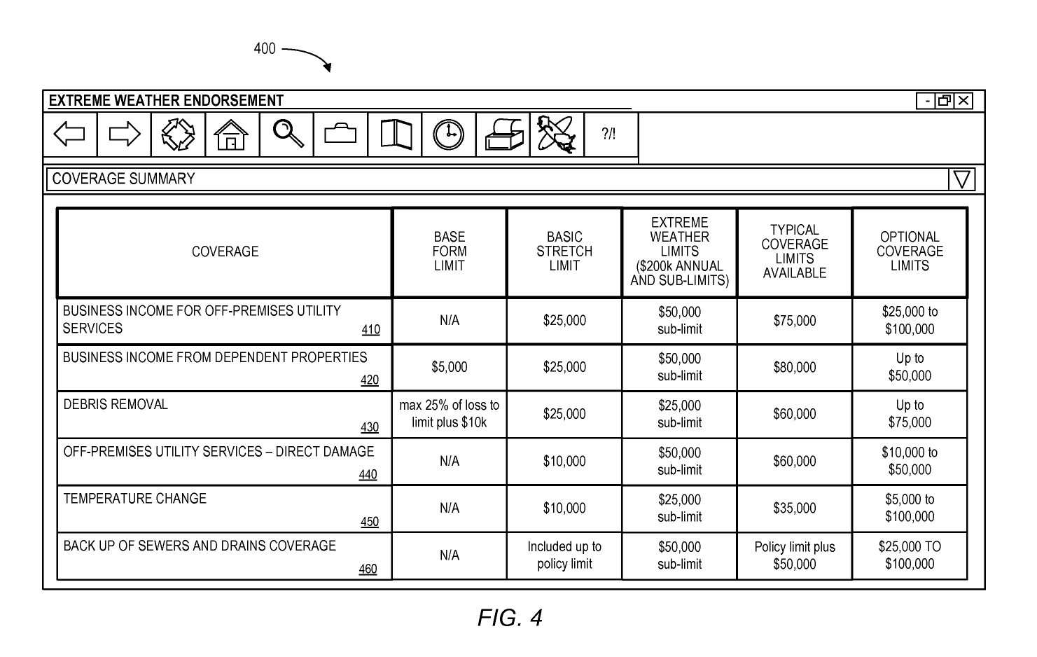

Based on the received information associated with the insurance claim, is may be determined at S230 if the insurance claim is associated with a type of loss (e.g., wind damage, etc.) that qualifies for coverage under an extreme weather endorsement of the base insurance policy and associated stretch endorsement. As described in more detail with respect to FIG. 4, only certain types of damages may be associated with an extreme weather endorsement. By way of example, it may be determined at S230 if the insurance claim is associated with one or more of the following types of damages or losses: business income for off-premises utility services, business income for dependent properties, debris removal, direct damage resulting from off-premises utilities service, temperature change, and sewer and drain backup coverage. If the insurance claim is not associated with one of those types of damages, the process may end at S260 without payment. That is, the insurance claim is not associated with the type of damages covered by the extreme weather endorsement.

If the insurance claim is associated with the appropriate type of loss at S230, it may then be determined at S240 if the extreme weather endorsement is associated with the insurance policy. For example, an insurance policy database may store an indication as to whether or not the consumer or insured purchased an extreme weather endorsement for his or her base insurance policy. If no extreme weather endorsement was purchased, the process may end at S260 without payment.

If an extreme weather endorsement is associated with the insurance policy at S240, it may be determined at S250 if the weather event satisfies an extreme weather trigger condition. For example, the trigger condition might require that a third party has classified the weather event as a catastrophic occurrence, such as a windstorm, a hailstorm, a tornado, a cyclone, a derecho, a named storm, a named hurricane, a snowstorm, a blizzard, an ice storm, a dust storm, a sand storm, a wildfire, and/or a brushfire. If the weather event does not satisfy the extreme weather trigger condition at S250, the process may end at S260 without payment.

If the weather event does satisfy the extreme weather trigger condition at S250, typical claim handling actions may be taken at S270 (e.g., to document and/or verify damages with appropriate documentation). Eventually, payment in connection with the insurance claim may be facilitated at S280. For example, an email or postal letter may be sent to the consumer indicating that the insurance claim has been approved. Moreover, check or bank transfer may be used to provide payment to the consumer.

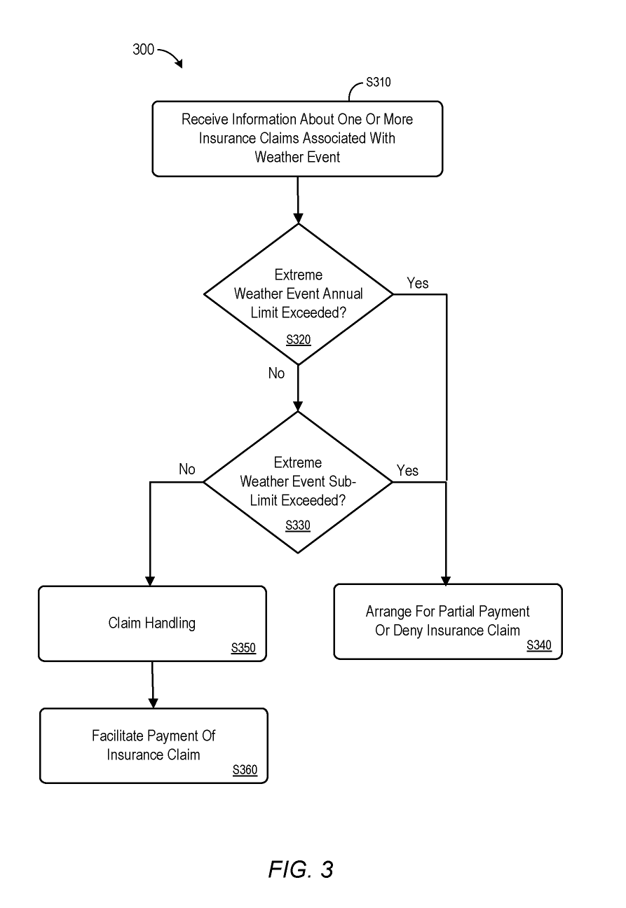

An extreme weather endorsement may, according to some embodiments, be associated with an overall annual limit and at least one coverage type sublimit. For example, the extreme weather endorsement may be associated with a $50,000 overall annual limit and a sub-limit of $5,000 for covering the costs associated with debris removal. FIG. 3 illustrates a method 300 associated with annual limits and sub-limits according to some embodiments of the present invention. At S310, information about one or more insurance claims may be received, each claim being associated with an extreme weather event. For example, a consumer might submit an insurance claim arising from a sand storm and an insurance claim database may be used to locate any other claims that have been filed by that consumer during the previous twelve months. At S320, it is determined if the newly filed insurance claim has caused the consumer's extreme weather event annual limit to be exceeded. If so, the insurer may arrange for a partial payment to the consumer (e.g., such that the total amount of payments equal the annual limit) at S340 or even deny the claim entirely (e.g., when the consumer has already reached the annual limit).

At S330, it is determined if the newly filed insurance claim has caused any of the consumer's extreme weather event sub-limits to be exceeded. If so, the insurer may arrange for a partial payment to the consumer (e.g., such that the total amount of payments equal the sub-limit) at S340 or even deny the claim entirely (e.g., when the consumer has already reached the sub-limit). If the annual limit or sub-limits are not a problem, the insurer may perform typical claim handling actions at S350 and facilitate payment of the entire insurance claim to the consumer at S360.

The sub-limits may be associated with the different types of damages that are covered by the extreme weather endorsement. FIG. 4 illustrates an example of an extreme weather endorsement coverage display 400 according to some embodiments. Note that the display 400 includes coverages associated with a base insurance, a stretch endorsement, and an extreme weather endorsement having an annual limit of $200,000. Of course, the particular coverage amounts described with respect to FIG. 4 are only examples, and different amounts and/or combinations of coverage packages may be provided (e.g., at different premiums).

In particular, the extreme weather endorsement may provide coverage for business income for off-premises utility services 410. For example, this might provide coverage for loss of business income or extra expenses caused by an interruption of service to the premises. According to some embodiments, a waiting period may be applied before the coverage takes effect (e.g., there might be a 72 hour waiting period). In the example illustrated in FIG. 4, this type of extreme weather damage may be associated with a $50,000 sub-limit. Note that this may include a $25,000 sub-limit for flood as a cause of loss at the off-premises utility.

The extreme weather endorsement may also provide coverage for business income for dependent properties 420. For example, this might provide business income protection for a loss at the insured premise due to a direct physical loss to a dependent property (e.g., another store, a major supplier, a major customer, or a major manufacturer). According to some embodiments, a waiting period may be applied before the coverage takes effect (e.g., there might be a 72 hour waiting period). In the example illustrated in FIG. 4, this type of extreme weather damage may be associated with a $50,000 sub-limit. Note that this may include a $25,000 sub-limit for flood as a cause of loss at the off-premises utility.

The extreme weather endorsement may also provide coverage for debris removal 430. For example, this might provide coverage for expenses the insured incurs for the removal of debris or covered property damaged by a covered cause of loss. In the example illustrated in FIG. 4, this type of extreme weather damage may be associated with a $25,000 sub-limit.

The extreme weather endorsement may also provide coverage for direct damage resulting from off-premises utilities service 440. For example, this might extend coverage to loss or damage to covered property on the premises caused by an interruption of water service, communication services, and/or power service. In the example illustrated in FIG. 4, this type of extreme weather damage may be associated with a $50,000 sub-limit.

The extreme weather endorsement may also provide coverage for temperature change damages 450. For example, this might provide coverage for spoilage caused by the change of temperature due to interruption of electrical power or mechanical breakdown or failure. In the example illustrated in FIG. 4, this type of extreme weather damage may be associated with a $25,000 sub-limit.

The extreme weather endorsement may also provide coverage for sewer and drain backup damages 460. For example, this might provide coverage for loss or damage to a covered property caused by water that backs up from a sewer or drain. In the example illustrated in FIG. 4, this type of extreme weather damage may be associated with a $50,000 sub-limit.

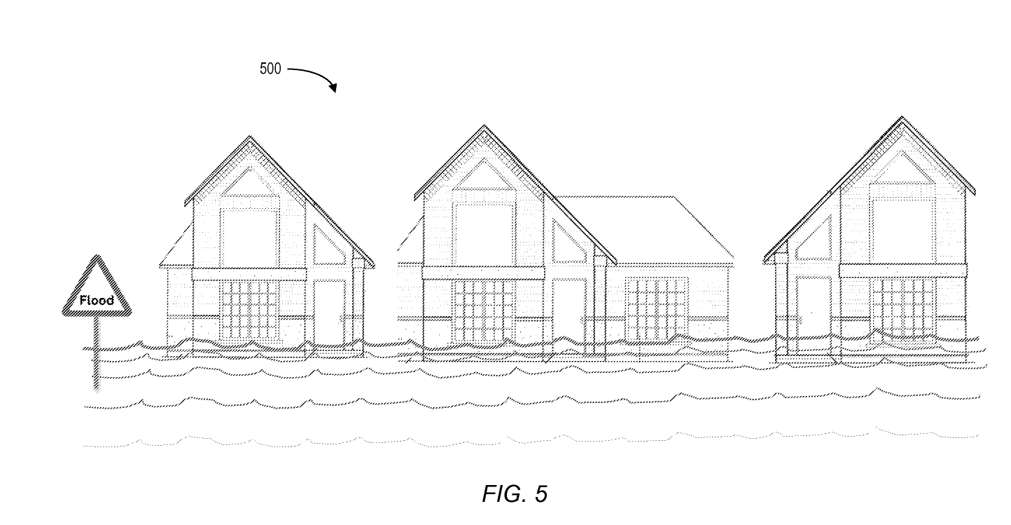

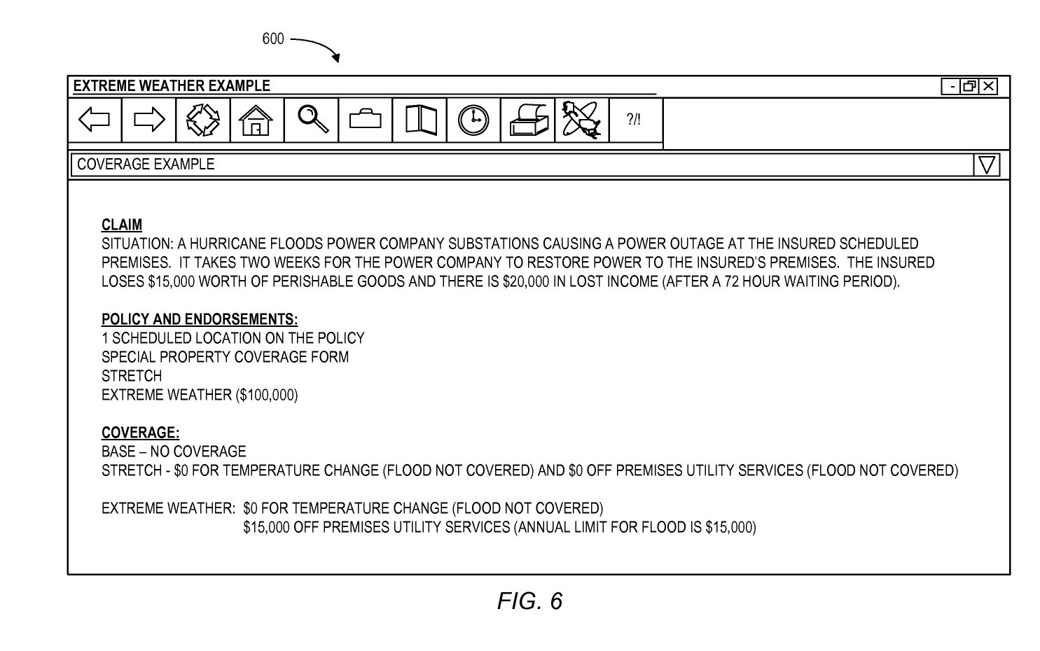

Consider, for example, FIG. 5 which is an example 500 of flood damage caused by a catastrophic weather event according to some embodiments. Moreover, in this example, assume that floods have destroyed power company substations causing a power outage an insured's place of business. FIG. 6 is an example 600 of an insurance claim processed according to some embodiments. In particular, the power remained out for two weeks and the insured lost $15,000 worth of perishable goods and had $20,000 in lost business income (after a 72 hour waiting period). Note that the insured has a base insurance policy and a stretch endorsement, and these do not cover flood damage. The insured also has an extreme weather endorsement which provides $15,000 coverage for the off-premises utility services (which is the annual limit in this example), but does not cover flood damage in connection with the temperature change loss. As a result, $15,000 of the insured's $20,000 damages in lost business income will be paid due to the extreme weather event.

As another example, consider a wildfire that burns downs a manufacturing plant that produced a specialized product used in an insured's business. Even though the insured did not sustain any physical damage, it did sustain substantial business interruption losses ($80,000 after a 72 hour waiting period) due to the break in the supply chain. Assume that the base insurance policy allows for $5,000 worth of business income loss due to dependent properties while the stretch endorsement covers $25,000. After those limits are reached, the insured may recover the remaining $50,000 of losses under the extreme weather endorsement.

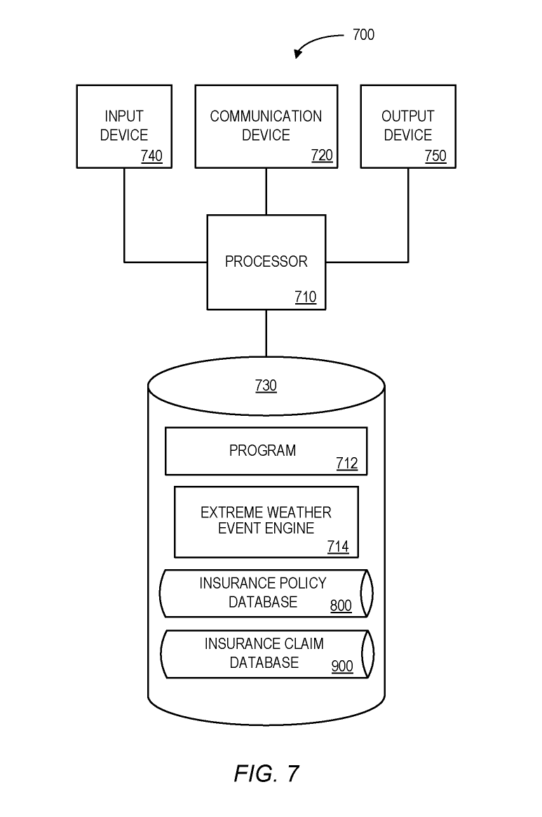

The embodiments described herein may be implemented using any number of different hardware configurations. For example, FIG. 7 illustrates a claims processing platform 700 that may be, for example, associated with the claims processing platform 140 of FIG. 1. The claims processing platform 700 comprises a processor 710, such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more remote consumer devices, insurance agent devices, underwriter devices, and/or third-party data services. The claims processing platform 700 further includes an input device 740 (e.g., a mouse, video camera, and/or keyboard to enter insurance claim and/or weather event information) and an output device 750 (e.g., a computer monitor to display messages and/or generate reports).

The processor 710 also communicates with a storage device 730. The storage device 730 may comprise any appropriate information storage device, including combinations of magnetic storage devices (e.g., a hard disk drive), optical storage devices, mobile telephones, vehicle computers, and/or semiconductor memory devices. The storage device 730 stores a program 712 and/or extreme weather event engine 714 for controlling the processor 710. The processor 710 performs instructions of the programs 712, 714, and thereby operates in accordance with any of the embodiments described herein. For example, the processor 710 may receive information about an insurance claim associated with a base insurance policy and a weather event. Based on the received information, the processor 710 may determine if the insurance claim is associated with an amount of loss that exceeds limits of the base insurance policy and stretch endorsement. The processor 710 may also determine if the insurance claim is associated with a type of loss covered by an extreme weather endorsement of the base insurance policy and associated stretch endorsement. Further, the processor 710 may determine if the extreme weather endorsement is associated with the insurance policy and if the weather event satisfies an extreme weather trigger condition. If the limits are exceeded, the type of loss is covered, the extreme weather endorsement is associated with the insurance policy, and the weather event satisfies the extreme weather trigger condition, payment in connection with the insurance claim may be facilitated by the processor 710.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the claims processing platform 700 from another device; or (ii) a software application or module within the claims processing platform 700 from another software application, module, or any other source.

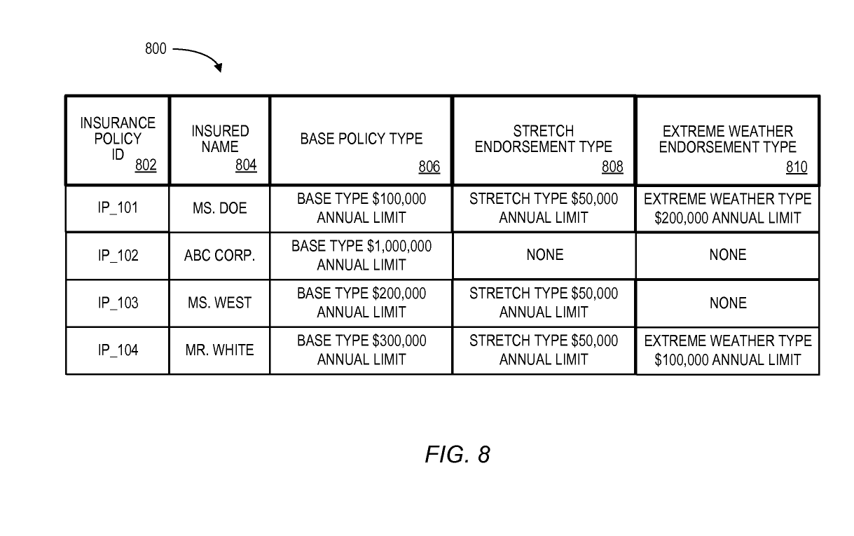

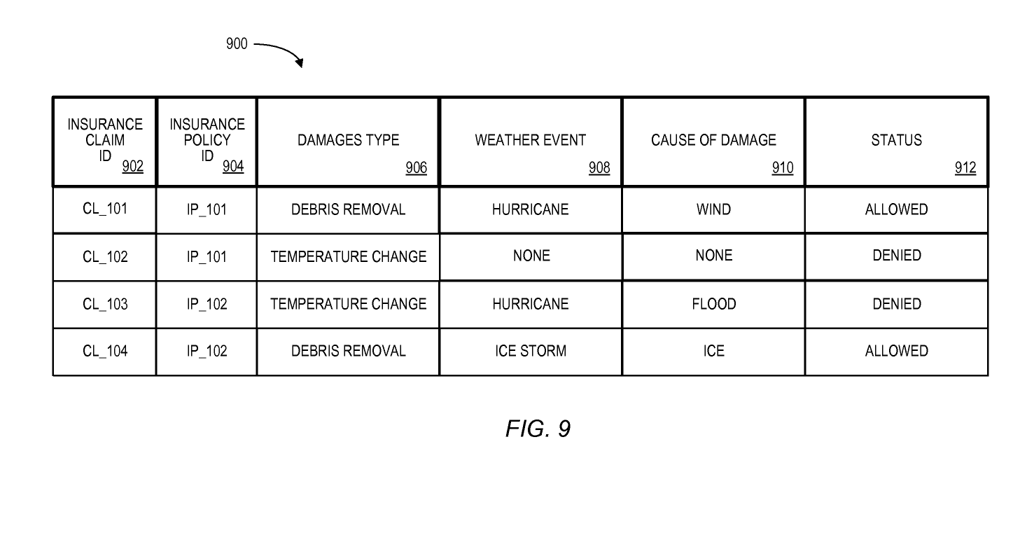

In some embodiments (such as shown in FIG. 7), the storage device 730 stores an insurance database 800 (described with respect to FIG. 8) and an insurance claim database 900 (e.g., described with respect to FIG. 9). Some examples of databases that might be used in connection with the claims processing platform 700 will now be described in detail with respect to FIGS. 8 and 9. Note that the databases described herein are only examples, and additional and/or different information may be stored therein. Moreover, various databases might be split or combined in accordance with any of the embodiments described herein.

FIG. 8 is a tabular portion of an insurance policy database 800 according to some embodiments. The table may include, for example, entries identifying insurance policies that have been sold to consumers. The table may also define fields 802, 804, 806, 808, 810 for each of the entries. The fields 802, 804, 806, 808, 810 may, according to some embodiments, specify: an insurance policy identifier 802, an insured name 804, a base policy type 806, a stretch endorsement type 808, and an extreme weather endorsement type 810. The information in the insurance policy database 800 may be created and updated, for example, whenever insurance policies are sold to consumers.

The insurance policy identifier 802 may be, for example, a unique alphanumeric code identifying a particular base insurance policy that has been issued to the insured name 804. The base policy type 806 may describe the base policy, and the stretch endorsement 808 may describe any stretch endorsements that are associated with the base insurance policy. The extreme weather endorsement type 810 may describe the extreme weather endorsement, if any, that is associated with the base insurance policy. For example, insurance policy IP_101 is associated with an extreme weather endorsement having a $200,000 annual limit and insurance policy IP_102 is associated with no extreme weather endorsement.

FIG. 9 is a tabular portion of an insurance claim database 900 according to some embodiments. The table may include, for example, entries identifying insurance claims that have been received from consumers. The table may also define fields 902, 904, 906, 908, 910, 912 for each of the entries. The fields 902, 904, 906, 908, 910, 912 may, according to some embodiments, specify: an insurance claim identifier 902, an insurance policy identifier 904, a damages type 906, a weather event 908, a cause of damage 9102, and a status 912. The information in the insurance policy database 900 may be created and updated, for example, whenever insurance claims are received from consumers.

The insurance claim identifier may be, for example, a unique alphanumeric code identifying a particular insurance claim that has been received from a consumer. The insurance policy identifier 904 may be, for example, a unique alphanumeric code identifying a particular base insurance policy that has been issued and may be based on, or associated with, the insurance policy identifier 802 described with respect to FIG. 8. The damages 906 may describe the type of injury or loss associated with the insurance claims (e.g., business income, debris removal, temperature change, etc.). The weather event 908 might indicate what caused the damages and may, for example, indicate if a third party has classified that particular event as a catastrophic occurrence. The cause of damage 910 may indicate what caused the damage associated with the insurance policy claim. The status 912 may indicate the current state of the insurance claim. In the example of FIG. 9, insurance claim CL_102 may have been denied because the weather event was not classified as catastrophic. Insurance claim CL_103 may have been denied, even though the weather event was classified as a catastrophic hurricane, because the associated insurance policy (IP_102) is not associated with an extreme weather endorsement.

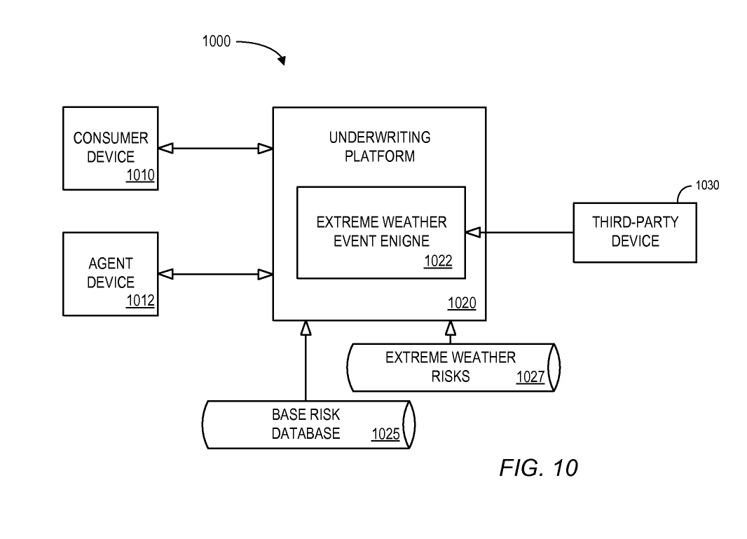

To help facilitate the provision of insurance associated with extreme weather events, FIG. 10 is a block diagram of a system 1000 according to some embodiments of the present invention. In particular, an underwriting platform 1020 may receive information from remote consumer devices 1010 and/or insurance agent devices 1012. The underwriting platform 1020 might be associated with, for example, an insurance company. The consumer devices 1010 and agent devices 1012 might comprise, for example, PCs, laptop computers, hand-held computers, wireless devices, smartphones, set-top boxes, and/or kiosks that can transmit information to and receive information from the underwriting platform 1020. By way of examples, a consumer device 1010 might be associated with a consumer's home computer, vehicle computer, or smartphone executing a browser or application that exchanges information with a web server associated with the underwriting platform 1020. Similarly, a consumer might transmit information via an agent device 1012. Based on information received from consumers, the underwriting platform 1020 may process a request for an extreme weather endorsement via an extreme weather event engine 1022 and transmit a quote and/or an indication that an endorsement has been issued to the consumer device 1010.

According to some embodiments, an automated underwriting platform 1020 and/or extreme weather event engine 1022 may facilitate an exchange of information. By way of example only, the underwriting platform 1020 and/or extreme weather event engine 1022 may include and/or communicate with a PC, an enterprise server, or a database farm. According to some embodiments, the underwriting platform 1020 and/or extreme weather event engine 1022 is further associated with a salesforce automation, a CRM application or a CSM/content management system.

As used herein, devices, including those associated with the claims processing platform the 1020, extreme weather event engine 1022, and any other device described herein, may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet. Note that any devices described herein may communicate via one or more such communication networks.

The underwriting platform 1020 may access information in one or more base risk databases 1025 and/or extreme weather risks databases 1027. The base risk databases 1025 and/or extreme weather risks databases 1027 may include, for example, information used to generate pricing quotes for insurance policies.

Although a single underwriting platform 1020 and a single extreme weather event engine 1022 are shown in FIG. 10, any number of such devices may be included. Moreover, various devices described herein might be combined according to embodiments of the present invention. For example, in some embodiments, the underwriting platform 1020, base risk databases 1025, and/or extreme weather risks databases 1027 might be co-located and/or may comprise a single apparatus.

According to some embodiments, the underwriting platform 1020 may also receive information from a remote third-party device 1030. The remote third-party device 1030 might be, for example, associated with a third party service that makes a determination as to whether or not an extreme weather event is likely imminent. For example, if a hurricane is forecast to hit an area in the next week, a “hurricane hold” might be issued such that no extreme weather endorsements are sold during that period of time. According to some embodiments, such a “hold”—may comprise an internal decision by the insurer, such that the insurer stops writing any new business if a peril (e.g., brush fire or hurricane) is imminent. For example, an enterprise risk management department of the insurer may in charge of this decision and its communication to employees, agents, etc.

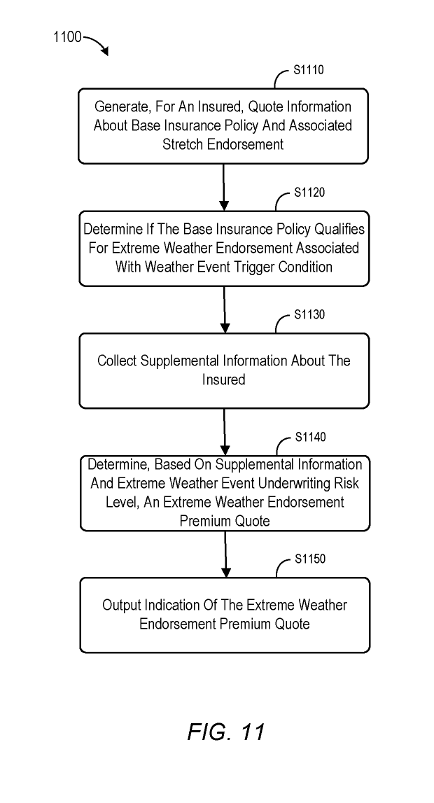

FIG. 11 illustrates a method that might be performed, for example, by some or all of the elements of the system 1000 described with respect to FIG. 10 according to some embodiments of the present invention. At S1110, quote information about a base insurance policy and associated stretch endorsement may be generated for an insured. Note that S1110 may be associated with, for example, an existing insurance policy, an insurance policy renewal, and/or a potential insurance policy.

At S1120, it may be determined if the base insurance policy qualifies for an extreme weather endorsement associated with a weather event trigger condition. The weather trigger condition may comprise, for example, classification of the weather event as a catastrophic occurrence by a third party. Note that the determination at S1120 may include verifying that a hurricane hold is not currently in effect.

At S1130, supplemental information about the insured may be collected. For example, the supplemental information might include a name, an address, a ZIP code, at least a portion of a Social Security number, a date of birth, demographic information, contact information, an insurance policy number, and/or a business type. For example, an insurer device might look up the supplemental information in a locally stored database. In the case of an insurance policy covering damage to automobiles, the supplemental information might include a Vehicle Identification Number (“VIN”), a number of vehicles, violation information, accident information, loss information, and/or information about other drivers associated with the potential consumer. In some cases, the supplemental information may be received from a third party device, as might be the case with credit score information, income information, governmental department of motor vehicles data, data aggregator information, and/or municipal record data. Other examples of supplemental information include a Standard Industrial Classification (“SIC”) code, a location of business operations, business revenue information, business payroll information, a construction type, and a business square footage.

At S1140, an extreme weather endorsement premium quote for the insured may be automatically determined, by a computer processor, based on the supplemental information and an extreme weather event underwriting risk level.

At S1150 an indication of the extreme weather endorsement premium quote may be output. For example, the premium might be told or displayed to a consumer. According to some embodiments, an indication of acceptance may be received from the insured, and payment of the extreme weather endorsement premium quote may be collected. The extreme weather endorsement may then be issued to the insured.

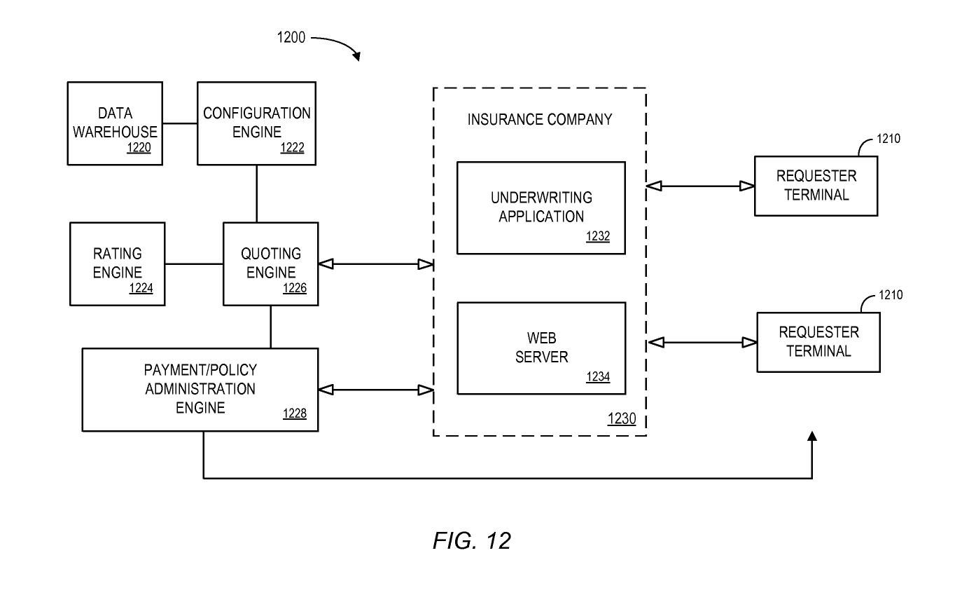

Features of some embodiments will now be described by first referring to FIG. 12 which illustrates a system architecture 1200 within which some embodiments may be implemented. More particularly, FIG. 12 depicts a system architecture 1200 in which comprehensive protection plans, including an extreme weather endorsement, may be quoted, priced, issued and managed. Although the devices of architecture 1200 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example architecture shown in FIG. 12, a number of requestor terminals 1210 are provided which comprise devices that may be operated by an insurance agent, a consumer, etc. seeking a recommendation of insurance coverages or information about policies including extreme weather endorsements. Requestor terminals 1210 may interact with Web pages provided by Web server 1234 to request a recommendation and to provide data relating to the kinds of property to be insured and information about the customer. This data may be transmitted to the insurance systems 1230 to determine a recommendation as described in detail below. More particularly, pursuant to some embodiments, the requests and applications may be associated with requests for an extreme weather endorsement. The requests may be received from individuals or entities seeking insurance coverage or for requests for insurance information. For example, with respect to applications for an extreme weather endorsement, the application data submitted via a requestor terminal 1210 may include information about a business, information about the insured, information about the limits and other options requested, or the like, but embodiments are not limited thereto.

As used herein, an insurance coverage “package” may comprise a set of one or more insurance coverages or policy features, such as extreme weather endorsement. Each of the one or more insurance coverages or features may insure against extreme weather events. In the present description, an insurance coverage defines the parameters of the risk(s) which are covered thereby, and a configuration is a package of one or more insurance coverages, including extreme weather endorsement specified limits and deductibles for each of the one or more insurance coverages.

Any number of requestor terminals 1210 may be employed to receive customer and insurance request data and to present insurance coverage and other information to operators of the requestor terminals 1210.

The requestor terminals 1210 may be in communication with an insurance company 1230 or other provider via a Web server 1234 or other front end interface that allows remote terminals to send and receive data to the insurance company. The customer and insurance request data are received via the Web server 1234 and are stored by data warehouse 1220 for later action. Any number or type of data storage systems may store the data in any suitable manner according to some embodiments. Non-exhaustive examples include a relational database system, a spreadsheet, and any other data structure that is amenable to parsing and manipulating data. A data warehouse 1220 may receive and store customer and application data as well as store insurance coverage package data and rules which are used in the quoting engine 1226 and the configuration engine 1222.

The configuration engine 1222 acts to receive the customer or insurance request data and to retrieve insurance coverage package data and rules from the data warehouse 1220. A configuration engine 1222 may identify one or more insurance coverage packages, including an extreme weather endorsement, based on the received data and on data received from Web server 1234. Pursuant to some embodiments, different insurance packages are assembled for presentation to the customer based on configuration rules and information associated with each policy term.

When an appropriate package (or packages) is identified by the configuration engine 1222, the package may be priced using the quoting engine 1226 and then presented to the customer or agent via a Web page or other user interface for viewing on a display screen of a requestor terminal 1210.

Note that each of the engines 1222, 1224, 1226, 1228 and the insurance systems 1230 may comprise any combination of hardware and/or processor-executable instructions stored on a tangible medium. According to some embodiments, one or more of the engines 1222, 1224, 1226 or 1228 may be a component of the data warehouse 1220 or the insurance systems 1230.

It should be noted that embodiments are not limited to the devices illustrated in FIG. 12. Each device may include any number of disparate hardware and/or software elements, some of which may be located remotely from one another. Functions attributed to one device may be performed by one or more other devices in some embodiments. The devices of system 1200 may communicate with one another (and with other non-illustrated elements) over any suitable communication media and protocols that are or become known.

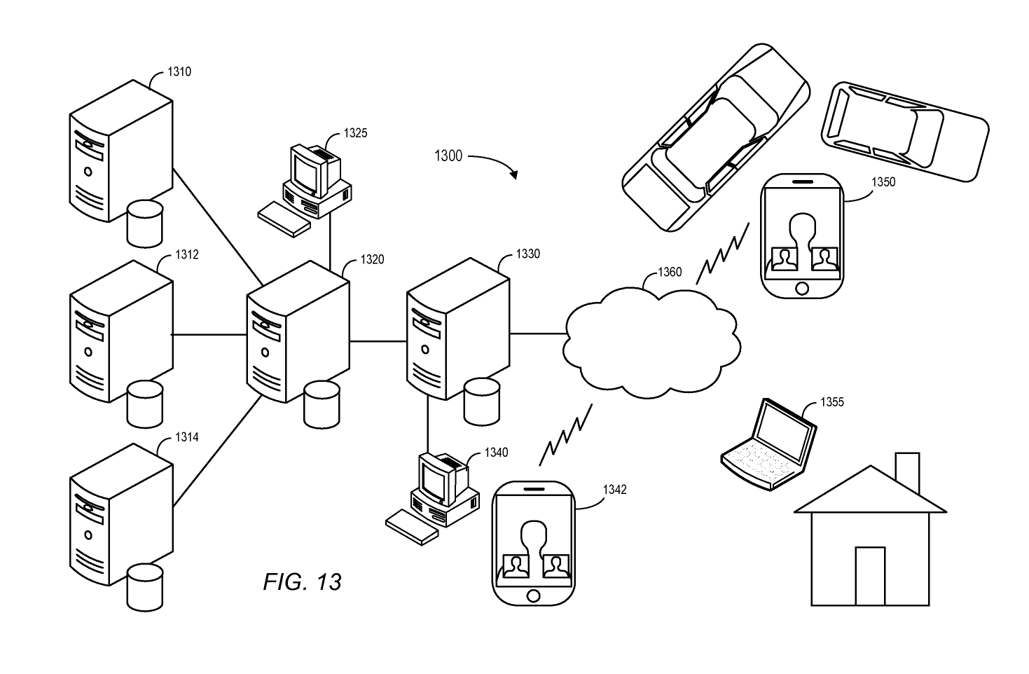

FIG. 13 illustrates claim processing architecture 1300 associated with an extreme weather endorsement according to some embodiments. Although some devices of architecture 1300 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 13, policy sources 1310 through 1314 store policy information associated with insurance policies and extreme weather endorsements. Policy information may include any combination of policy-related data fields that are or become known, including but not limited to policy type, policy number, insured name, deductibles, coverage limits, riders, stretch endorsement, and exceptions. Each of policy sources 1310 through 1314 may comprise any combination of hardware and/or software, including but not limited to relational databases, application servers, and spreadsheets. One or more of policy sources 1310 through 1314 may comprise a policy issuing system, a data warehouse of an insurance company or any other aggregator of insurance policy information.

Pursuant to some embodiments, the policy source 1310 is a source of extreme weather endorsements which have been issued by an insurer. Each of policy sources 1310 through 1314 may provide policy information to system 1320 asynchronously or according to any schedule. In some embodiments, one or more of policy sources 1310 through 1314 provides a daily feed of policy information to system 1320. The policy information of the feed may be associated with new insurance policies for which an initial premium has been paid.

A system 1320 may comprise any combination of hardware and software to perform processes as described herein. According to some embodiments, when an insured party submits a claim or request for information about a policy, the system 1320 receives policy information associated with an insurance policy from one of sources 1310 through 1314 and processes the claim or other request. In the event that an insured party submits a claim involving a policy issued pursuant to some embodiments, any of the processes described herein may be performed. In general, however, when a request is received involving a policy stored in one of the policy sources 1310 through 1314, the data is retrieved and returned to system 1320 for processing.

The system 1320, as well as claims management system 1330 may comprise program instructions of a database management system, database procedures and/or database applications to process the data stored at those systems or retrieved by those systems. One or more administrator terminals 1325 may be operated to edit this data and to otherwise provide commands to system 1320. For example, an administrator terminal 1325 may be operated to update a data structure including information associated with a claim or the like. A terminal 1325 may comprise any suitable device, including but not limited to a desktop computer.

The claim management system 1330 may receive policy records and associated claim handling identifiers from system 1320. The claim management system 1330 may receive a report of a claim associated with an insurance policy and determine the claim handling identifier of the record associated with the insurance policy. A customer service representative may use the claim handling identifier to assign the claim to the appropriate claim-handling organization. In this regard, customer service representatives may operate terminals 1340 and 1342 to access the records of claim management system 1330. All terminals described herein may comprise any suitable devices for requesting and displaying user interfaces, including but not limited to desktop computers, cellular telephones, personal digital assistants, and laptops.

According to some examples, an insured individual suffers a loss which involves an extreme weather event and submits a claim to an insurance processing system 1330 over a network interface (for example, the claim may be submitted using a phone 1350 or a computer terminal 1355).

Whether the claim is submitted via a phone 1350 or a computer terminal 1355, the claim request is routed to a telephone 1342 associated with a customer service representative. For example, the insured individual (who suffered extreme weather event losses) may operate a telephone 1350 to call a claim-reporting telephone number provided by an insurance company. The call is passed through a network 1360 (e.g., the PSTN, a cellular network, and/or an IP network) and terminates at telephone 1342 of a customer service representative. Embodiments may also or alternatively provide claim reporting via one or more other communication modes, such as facsimile, electronic mail, or World Wide Web.

The customer service representative receives an identifier of the insured's policy (e.g., policy number, social security number, etc.) and operates a client application executed by terminal 1340 to retrieve a record of claim management system 1330 associated with the policy and extreme weather endorsement. The customer service representative determines a claim handling identifier of the record and assigns the claim based thereon. Depending on the nature of the claim handling identifier, assignment of the claim may include providing a telephone number of a third-party administrator to the insured or transferring the telephone call to a claim-handling organization of the insurance company. A process is then performed by the claim management system 1330 to determine if the claim relates to an extreme weather endorsement of the present invention and, if so, whether or not a catastrophic occurrence caused the damages.

The insurance system 1300 of FIG. 13 may provide other administration and maintenance features associated with policies issued pursuant to the present invention. For example, a system server 1320 may operate to receive and process policy change or update requests and may generate an interface or display screens to allow faster and easier policy service. Agents and insureds may interact with the system 1320 to manage customers policy changes in real-time by performing actions such as: (i) add, replace, delete or change insured locations and coverages; (ii) quote “what if” scenarios and save them for later, (iii) provide an immediate or substantially real time confirmation on a wide variety of policy changes, (iv) view a billing breakdown, print ID cards and forms, etc.

The server 1320 may also include a vendor interface to control communications between third party vendor systems and claim data associated with claims processed using claims processing system 1320. For example, a vendor interface may facilitate communication to secure vendor services for a customer who has initiated a claim. As a specific illustrative example, for a customer who has initiated a claim for extreme weather event damages, a list of preferred contractors in the customer's area may be automatically generated (and similarly, a notification may be transmitted to one or more contractors of the customer's need for repairs).

In some embodiments, the server 1320 may also include a notification module or code administering and applying notification and messaging rules associated with individual extreme weather endorsements pursuant to the present invention. For example, the notification code may operate to generate one or more notifications to insured customers or vendors. As a specific example, all active policies stored in policy stores 1310-314 may be monitored to identify any upcoming or recent “trigger” weather events or dates, as well as the expiration or activation of a benefit.

It should be noted that embodiments are not limited to the devices illustrated in FIG. 13. Each device may include any number of disparate hardware and/or software elements, some of which may be located remotely from one another. Functions attributed to one device may be performed by one or more other devices in some embodiments. The devices of system 1300 may communicate with one another (and with other non-illustrated elements) over any suitable communication media and protocols that are or become known.

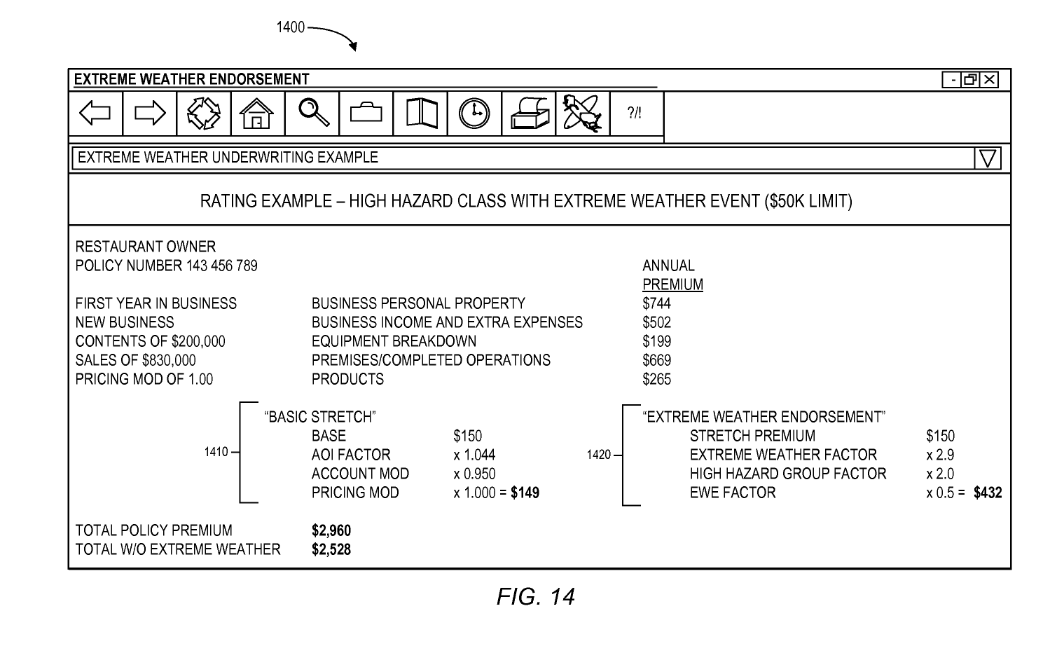

FIG. 14 illustrates an insurance pricing example display 1400 in accordance with some embodiments. In this example, annual premium amounts are generated based on the type of business, the worth of property, etc. Moreover, an underwriting quote for a basic stretch endorsement 1410 is calculated (e.g., by applying various factors and modifiers (including, for example, an Amount Of Insurance (“AOI”) factor, an account modifier to give discounts to customers who purchase multiple types of insurance from the same insurance company, and a pricing modifier that might be applied at an agent's discretion) to a base amount to generate a quote of $149). The amount of the stretch endorsement can then serve as a base for an underwriting quote for an extreme weather endorsement 1420 (e.g., by applying various factors to the stretch amount to generate a quote of $432). In particular, an extreme weather factor might be applied to all extreme weather endorsements or, according to some embodiments, may vary based on the geographical location of the insured (e.g., with costal properties having a greater risk of hurricanes, etc.). Similarly, a high hazard group factor might be applied based on insured's type of business (e.g., with restaurants having a larger risk of substantial damages due to temperature changes).

Thus, embodiments may facilitate the provision of insurance and payment of claims associated with extreme weather events in an efficient and accurate manner. As a result, consumers may receive improved protections from catastrophic occurrences at a reasonable cost.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance premium quotes. Note, however, that other types of insurance information may also be associated with embodiments described herein. For example, embodiments of the present invention may be used in connection with insurance claims handlers and/or handling processes, workers' compensation claims, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An insurance claims processing system associated with a base insurance policy having a stretch endorsement, comprising:
a communication device to receive information about an insurance claim associated with the base insurance policy and a weather event;
a computer processor for executing program instructions; and
a memory, coupled to the computer processor, for storing program instructions for execution by the computer processor to:
based on the received information associated with the insurance claim, determining if the insurance claim is associated with an amount of loss that exceeds limits of the base insurance policy and stretch endorsement;
determining if the insurance claim is associated with a type of loss covered by an extreme weather endorsement of the base insurance policy and associated stretch endorsement;
determining if the extreme weather endorsement is associated with the insurance policy;
determining if the weather event satisfies an extreme weather trigger condition; and
if the limits are exceeded, the type of loss is covered, the extreme weather endorsement is associated with the insurance policy, and the weather event satisfies the extreme weather trigger condition, facilitating payment in connection with the insurance claim.

2. The system of claim 1, where the weather trigger condition is classification of the weather event as a catastrophic occurrence by a third party.

3. The system of claim 2, wherein the catastrophic occurrence is associated with at least one of: (i) a windstorm, (ii) a hailstorm, (iii) a tornado, (iv) a cyclone, (v) a derecho, (vi) a named storm, (vii) a named hurricane, (viii) a snowstorm, (ix) a blizzard, (x) an ice storm, (xi) a dust storm, (xii) a sand storm, (xiii) a wildfire, and (xiv) a brushfire.

4. The system of claim 1, wherein the extreme weather endorsement is associated with an overall annual limit, a first sublimit associated with a first loss type and a second sublimit associated with a second loss type, wherein the second sublimit is different than the first sublimit.

5. The system of claim 1, wherein the overage type sublimit is associated with at least one of: (i) business income for off-premises utility services, (ii) business income for dependent properties, (iii) debris removal, (iv) direct damage resulting from off-premises utilities service, (v) temperature change, and (vi) sewer and drain backup coverage.

6. The system of claim 1, wherein the extreme weather endorsement is associated with a plurality of separate locations.

7. A computer-implemented insurance claims processing method associated with a base insurance policy having a stretch endorsement, comprising:
receiving, at a computer processor of a claims processing platform, information about an insurance claim associated with the base insurance policy and a weather event;
based on the received information associated with the insurance claim, determining, by the computer processor of the claims processing platform, if the insurance claim is associated with an amount of loss that exceeds limits of the base insurance policy and stretch endorsement;
determining, by the computer processor of the claims processing platform, if the insurance claim is associated with a type of loss covered by an extreme weather endorsement of the base insurance policy and associated stretch endorsement;
determining if the extreme weather endorsement is associated with the insurance policy;
determining if the weather event satisfies an extreme weather trigger condition; and
if the limits are exceeded, the type of loss is covered, the extreme weather endorsement is associated with the insurance policy, and the weather event satisfies the extreme weather trigger condition, facilitating payment in connection with the insurance claim.

8. The method of claim 7, where the weather trigger condition is classification of the weather event as a catastrophic occurrence by a third party.

9. The method of claim 8, wherein the catastrophic occurrence is associated with at least one of: (i) a windstorm, (ii) a hailstorm, (iii) a tornado, (iv) a cyclone, (v) a derecho, (vi) a named storm, (vii) a named hurricane, (viii) a snowstorm, (ix) a blizzard, (x) an ice storm, (xi) a dust storm, (xii) a sand storm, (xiii) a wildfire, and (xiv) a brushfire.

10. The method of claim 7, wherein the extreme weather endorsement is associated with an overall annual limit, a first sublimit associated with a first loss type and a second sublimit associated with a second loss type, wherein the second sublimit is different than the first sublimit.

11. The method of claim 7, wherein the overage type sublimit is associated with at least one of: (i) business income for off-premises utility services, (ii) business income for dependent properties, (iii) debris removal, (iv) direct damage resulting from off-premises utilities service, (v) temperature change, and (vi) sewer and drain backup coverage.

12. The method of claim 7, wherein the extreme weather endorsement is associated with a plurality of separate locations.

13. An insurance underwriting system, comprising:
a communication device to receive a request for an extreme weather endorsement premium quote;
a computer processor coupled to the communication device for executing program instructions; and
a memory, coupled to the computer processor, for storing program instructions for execution by the computer processor to:
generate quote information about a base insurance policy and associated stretch endorsement for an insured,
determine if the stretch endorsement qualifies for an extreme weather endorsement associated with a weather event trigger condition,
collect supplemental information about the insured,
determine, based on the supplemental information and an extreme weather event underwriting risk level, the extreme weather endorsement premium quote for the insured, and
output an indication of the extreme weather endorsement premium quote.

14. The system of claim 13, where the weather trigger condition is classification of the weather event as a catastrophic occurrence by a third party.

15. The system of claim 14, wherein the catastrophic occurrence is associated with at least one of: (i) a windstorm, (ii) a hailstorm, (iii) a tornado, (iv) a cyclone, (v) a derecho, (vi) a named storm, (vii) a named hurricane, (viii) a snowstorm, (ix) a blizzard, (x) an ice storm, (xi) a dust storm, (xii) a sand storm, (xiii) a wildfire, and (xiv) a brushfire.

16. The system of claim 13, wherein the supplemental insurance information comprises at least one of: (i) a name, (ii) an address, (iii) a ZIP code, (iv) at least a portion of a Social Security number, (v) a date of birth, (vi) demographic information, (vii) contact information, (viii) an insurance policy number, (ix) a business type, (x) a Vehicle Identification Number, (xi) a number of vehicles, (xii) violation information, (xiii) accident information, (xiv) loss information, (xv) information about other drivers associated with the potential consumer, (xvi) credit score information, (xvii) income information, (xviii) third party data, (xix) governmental department of motor vehicles data, (xx) data aggregator information, (xxi) municipal record data, (xxii) a Standard Industrial Classification code, (xxiii) a location of business operations, (xxiv) business revenue information, (xxv) business payroll information, (xxvi) a construction type, and (xxvii) a business square footage.

17. The system of claim 13, wherein the insurance policy comprises one of: (i) an existing insurance policy, (ii) an insurance policy renewal, and (iii) a potential insurance policy.

18. The system of claim 13, wherein said determining if the insurance policy qualifies for the extreme weather endorsement comprises verifying that a hurricane hold is not currently in effect.

19. The system of claim 13, further comprising:
receiving an indication of acceptance from the insured;
collecting payment of the extreme weather endorsement premium quote; and
issuing the extreme weather endorsement to the insured.

20. The system of claim 13, wherein the determination of the extreme weather endorsement premium includes:
storing an indication of a stretch endorsement premium amount;
storing an extreme weather endorsement risk modifier value; and
multiplying the stretch endorsement premium amount by the extreme weather endorsement risk modifier value.

21. An insurance underwriting method, comprising:
generating, by a computer processor of an underwriting platform, quote information about a base insurance policy and associated stretch endorsement for an insured,
determining, by the computer processor of the underwriting platform, if the stretch endorsement qualifies for an extreme weather endorsement associated with a weather event trigger condition,
collecting supplemental information about the insured,
determining, by the computer processor of the underwriting platform, based on the supplemental information and an extreme weather event underwriting risk level, the extreme weather endorsement premium quote for the insured, and
outputting, from the computer processor of the underwriting platform, an indication of the extreme weather endorsement premium quote.

22. The method of claim 21, where the weather trigger condition is classification of the weather event as a catastrophic occurrence by a third party.

23. The method of claim 22, wherein the catastrophic occurrence is associated with at least one of: (i) a windstorm, (ii) a hailstorm, (iii) a tornado, (iv) a cyclone, (v) a derecho, (vi) a named storm, (vii) a named hurricane, (viii) a snowstorm, (ix) a blizzard, (x) an ice storm, (xi) a dust storm, (xii) a sand storm, (xiii) a wildfire, and (xiv) a brushfire.

24. The method of claim 21, wherein the supplemental insurance information comprises at least one of: (i) a name, (ii) an address, (iii) a ZIP code, (iv) at least a portion of a Social Security number, (v) a date of birth, (vi) demographic information, (vii) contact information, (viii) an insurance policy number, (ix) a business type, (x) a Vehicle Identification Number, (xi) a number of vehicles, (xii) violation information, (xiii) accident information, (xiv) loss information, (xv) information about other drivers associated with the potential consumer, (xvi) credit score information, (xvii) income information, (xviii) third party data, (xix) governmental department of motor vehicles data, (xx) data aggregator information, (xxi) municipal record data, (xxii) a Standard Industrial Classification code, (xxiii) a location of business operations, (xxiv) business revenue information, (xxv) business payroll information, (xxvi) a construction type, and (xxvii) a business square footage.

25. The method of claim 21, wherein the insurance policy comprises one of: (i) an existing insurance policy, (ii) an insurance policy renewal, and (iii) a potential insurance policy.

26. The method of claim 21, wherein said determining if the insurance policy qualifies for the extreme weather endorsement comprises verifying that a hurricane hold is not currently in effect.

27. The method of claim 21, further comprising:
receiving an indication of acceptance from the insured;
collecting payment of the extreme weather endorsement premium quote; and
issuing the extreme weather endorsement to the insured.

28. The method of claim 21, wherein the determination of the extreme weather endorsement premium includes:
storing an indication of a stretch endorsement premium amount;
storing an extreme weather endorsement risk modifier value; and
multiplying the stretch endorsement premium amount by the extreme weather endorsement risk modifier value.
